(19) United States
(12) Patent Application Publication
(10) Pub. No.: US 2019/0077231 A1
(43) Pub. Date: Mar. 14, 2019

(54) APPARATUS INCLUDING LOCKING DIVISION BAR

(71) Applicant: FORD GLOBAL TECHNOLOGIES, LLC, Dearborn, MI (US)

(72) Inventors: Paul L. Heirtzler, JR., Northville, MI (US); Donald P. Iacovoni, Plymouth, MI (US); Kyle Otremba, Farmington Hills, MI (US); Henry W. Hausler, South Lyon, MI (US)

(21) Appl. No.: 15/698,740

(22) Filed: Sep. 8, 2017

(51) Int. Cl. B60J 5/04; E05D 15/16; B60J 1/17

(52) U.S. Cl. CPC B60J 5/0416; E05F 15/60; B60J 1/17; E05D 15/165

(57) ABSTRACT

An apparatus includes a door panel and a division bar carried on the door panel. The division bar is displaceable between a stowed position, concealed within the door panel, and a deployed position projecting above the door panel. A biasing element biases the division bar toward the stowed position. A releasable locking feature secures the division bar in the deployed position.

### TECHNICAL FIELD

This document relates generally to the motor vehicle equipment field and, more particularly, to a new and improved apparatus for fully lowering a window and a division bar wherein the division bar may be locked in a raised position if desired.

### BACKGROUND

In motor vehicle applications, there are challenges with designing movable windows or door glass to drop inside of the door structure. Often, the shape of the lower door structure does not accommodate the complete lowering of a full door glass window using traditional automotive hardware systems. This is typically an issue on rear side doors, where the location of the rear wheel well might necessitate a certain shape and size of the lower door structure that is smaller than desired, or on a front door with an outside rearview mirror that is not mounted above the belt line.

In the past this problem has generally been resolved by one of two compromises. In the first of these compromises, illustrated in FIG. 1a, the window or door glass W does not drop completely below the belt line B found on the door at the lower side of the window frame. In this situation, the vehicle occupant does not have a comfortable place to rest his arm when the window is down. Further, there is only limited room to pass items through the opening O above the window and the portion of the opening remaining covered by the window significantly limits available ventilation.

In option number 2, illustrated in FIG. 1b, the size of the movable portion of the window or door glass W is reduced so that portion may be fully opened and dropped into the door panel P. Unfortunately, this compromise limits the size of the window opening above the door and increases the cost and complexity of the window system due to, for example, the addition of a fixed piece of glass G and the division bar seal S or an applique that blocks a portion of the daylight opening.

This document relates to a new and improved apparatus that allows the full lowering of a window and division bar into the door panel below the beltline while avoiding the compromises set forth above. The apparatus also includes a locking feature to secure the division bar in a raised or deployed position when desired.

### SUMMARY

In accordance with the purposes and benefits described herein, a new and improved apparatus is provided for fully lowering a window and division bar into a door panel so as to provide a full window opening above the door panel. That apparatus comprises a door panel and a division bar carried on the door panel. That division bar is displaceable between a stowed position concealed within the door panel and a deployed position. The apparatus further comprises a biasing element biasing the division bar toward the stowed position and a locking feature. The locking feature secures the division bar in the deployed position when one desires to retain the division bar in the deployed position when the window carried in the door panel is lowered.

The locking feature may further include a locking pin carried on the door panel and a pin receiver carried on the division bar. The apparatus may further include a mechanical actuator to displace the locking pin between a pin receiver engaging position and a pin receiver releasing position. That mechanical actuator may include a control knob. Further, the mechanical actuator may include a return spring.

In other possible embodiments, the apparatus includes an automechanical actuator to displace the locking pin between a pin receiver engaging position and a pin receiver releasing position. That electromechanical actuator may include a solenoid and a remote actuator switch.

The division bar of the apparatus may be mounted on a pivot pin carried on the door panel. Further, the biasing element may be a torsion spring concentrically received over the pivot pin.

In accordance with an additional aspect, the door panel of the apparatus may include a window receiver and an internal compartment. Further, the apparatus may include a window and a regulator carried on the door panel. The regulator displaces the window between a closed position, projecting from the window receiver, and an opened position concealed within the internal compartment.

The regulator may further include a guide rail system for guiding the window as the window is displaced between the closed positon and the opened position. Further, an edge of the window may engage the division bar when the window projects above the pivot pin. That edge acts to hold the division bar in the deployed position against the biasing force of the biasing element when the locking feature is released. In some of the many possible embodiments, the division bar straddles the window.

In the following description, there are shown and described several preferred embodiments of the apparatus. As it should be realized, the apparatus is capable of other, different embodiments and its several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and the method and together with the description serve to explain certain principles thereof.

FIG. 1a illustrates one type of prior art compromise made when a door panel will not accommodate fully opening a full-size window or door glass.

FIG. 1b illustrates a second type of prior art compromise when a door panel will not accommodate fully opening a full-size window or door glass.

FIG. 2a is a schematic illustration of the apparatus showing the window and division bar in the closed position.

FIG. 2b is an illustration similar to FIG. 2a but showing the window and division bar in the opened position.

FIGS. 3a-3f are a series of schematic illustrations showing the movements of the window and division bar as the window and division bar are displaced between the fully closed position illustrated in FIG. 3a and the fully opened position illustrated in FIG. 3f.

FIG. 4 is a schematic illustration of a first embodiment of a locking feature for securing the division bar in a raised or deployed position when the window is opened as illustrated in FIGS. 2a-2b and 3a-3f.

FIGS. 5 is a schematic illustration of a second embodiment of a locking feature for securing the division bar in a raised or deployed position when the window is opened as illustrated in FIGS. 2a-2b and 3a-3f.

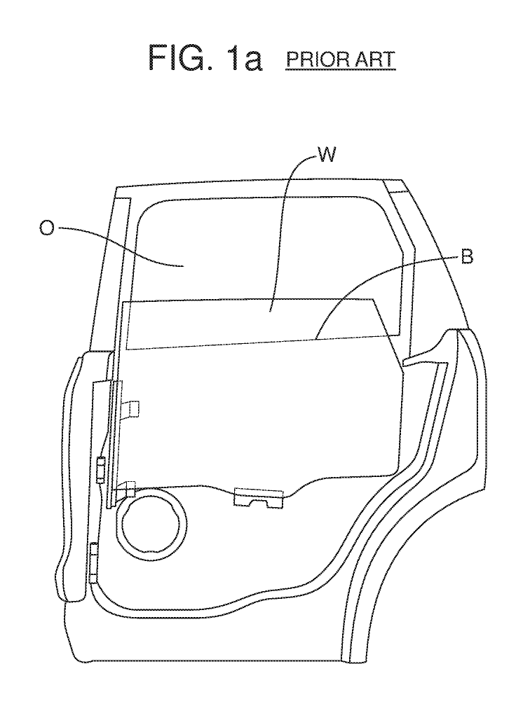

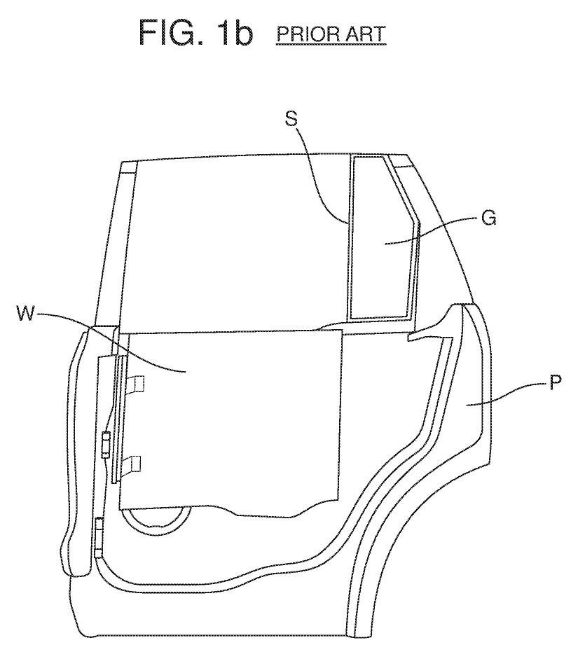

Reference will now be made in detail to the present preferred embodiments of the apparatus, examples of which are illustrated in the accompanying drawing figures.

### DETAILED DESCRIPTION

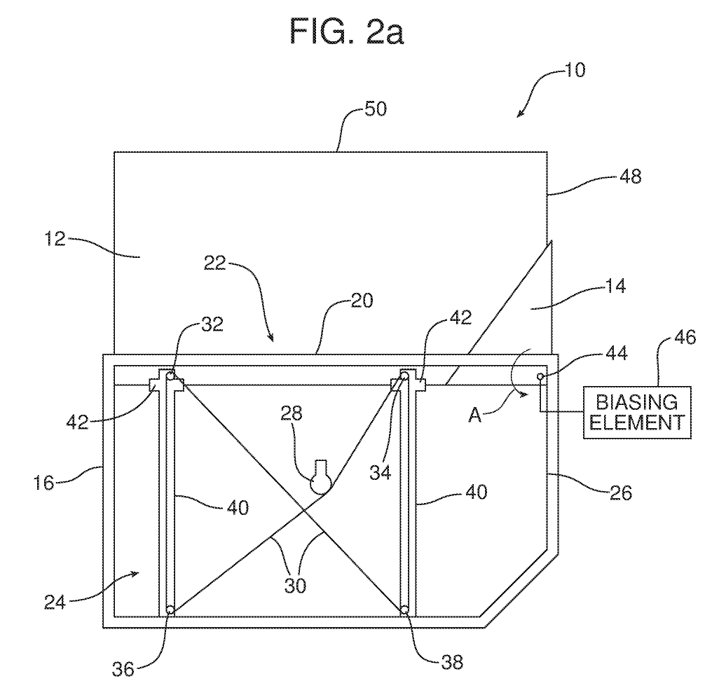

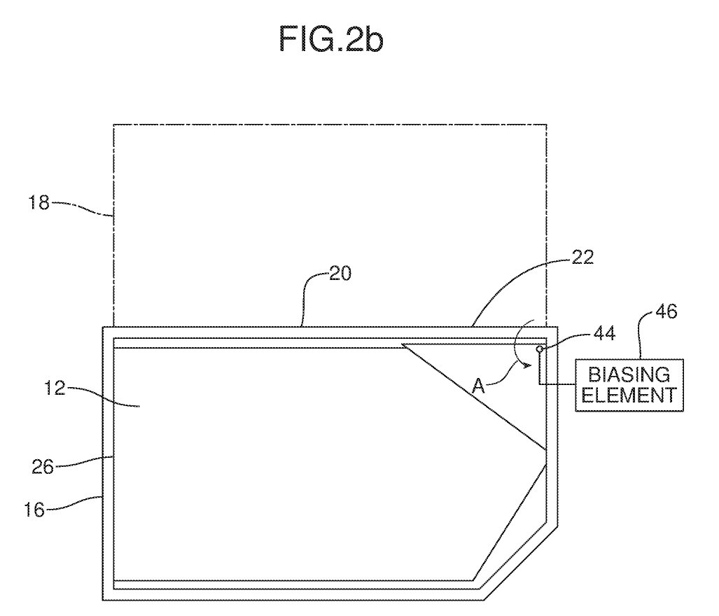

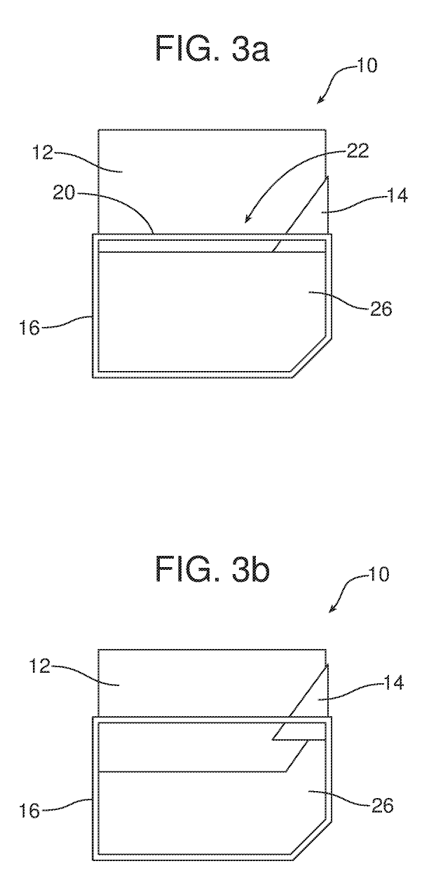

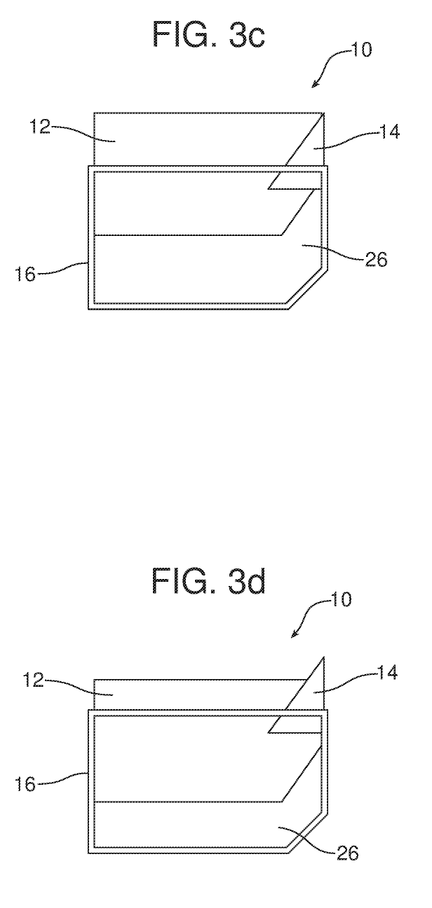

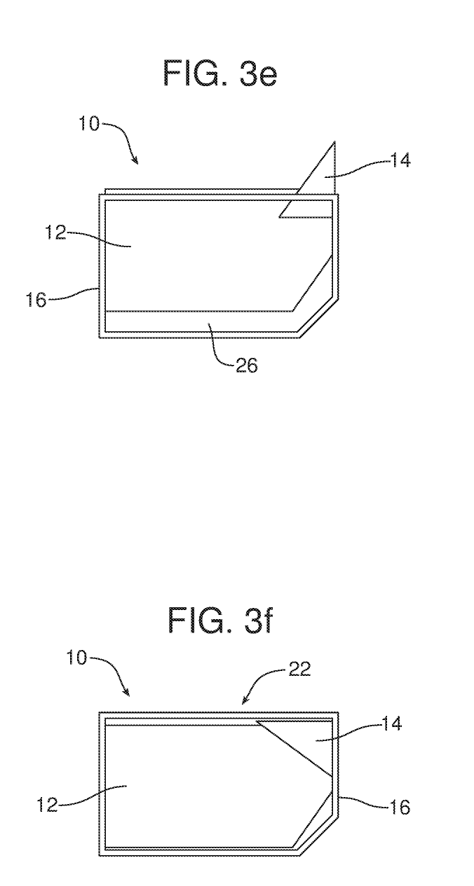

Reference is now made to FIGS. 2a, 2b and 3a-3f illustrating a first possible embodiment of the new and improved apparatus 10 for fully lowering a window 12 and cooperating division bar 14 into a door panel 16 and providing a full-size opening 18 above the door panel. The door panel 16 has a window receiver 20 along the top edge of the door panel 16 which forms part of a belt line of the motor vehicle.

The window 12 and the division bar 14 are carried on the door panel 16. A regulator 24 is carried in an internal compartment 26 of the door panel 16. As will be apparent from the following description, the regulator 24 displaces the window 12 and the division bar 14 between a fully raised or closed position illustrated in FIG. 2a wherein the window and the division bar project above the door panel through the window receiver 20 and an opened position, illustrated in FIG. 2b wherein the window and division bar 14 are lowered below the top edge and the belt line 22 of the motor vehicle and fully concealed within the internal compartment 26 of the door panel 16.

In the illustrated embodiment, the regulator 24 comprises a single drive motor 28 and cooperating cable drive system 30 stretched over a series of pulleys 32, 34, 36, 38. The regulator 24 also includes a guide rail system comprising two guide rails 40. Two window lift brackets 42 connected to the window 12 slide along the guide rails 40 as the window 12 and the division bar 14 are displaced between the closed and opened positions by the drive motor 28. The window regulator 24 is fully illustrated in FIG. 2a but has been removed from FIGS. 2b and 3a-3f in order to more clearly illustrate the operation of the window 12 and the division bar 14.

As further illustrated in FIGS. 2a, 2b and 3a-3f, the division bar 14 is pivotally mounted on a pivot in the form of a pivot pin 44 carried on the door panel 16. The apparatus 10 also includes a biasing element 46 for biasing the division bar 14 toward the opened position illustrated in FIGS. 2b and 3f. In the illustrated embodiment, the biasing element 46 is a torsion spring concentrically received over the pivot pin 44.

The operation of the first embodiment of the apparatus 10 illustrated in FIGS. 2a, 2b and 3a-3f will now be described in detail. As the window 12 is initially displaced from the fully closed position illustrated in FIGS. 2a and 3a to the fully opened position illustrated in FIGS. 2b and 3f, the window 12 is lowered through the window receiver 20 into the internal compartment 26 of the door panel 16 by the regulator 24. The division bar 14 is held and maintained in a first position projecting through the window receiver 20 above the door panel 16 until the window drops below (a) the top edge of the door panel 16/the belt line 22 of the motor vehicle and (b) the pivot pin 44 in the door panel 16. See FIGS. 3a-3e. More specifically, the edge 48 of the window 12 engages the division bar 14 holding it in this first position.

Once the window 12 is lowered below the pivot pin 44, the trailing edge 48 of the window 12 no longer contacts the division bar 14 and the division bar 14 is then biased by the biasing element 46 so as to pivot about the pivot pin 44 in the direction of action arrow A. Here it should be appreciated that the division bar 14 straddles the window 12 and the biasing element 46 functions to displace the division bar 14 until the division bar rests over a top edge 50 of the window 12 in a second, lowered position fully concealed within the door panel 16.

When the window 12 is displaced from the opened position illustrated in FIGS. 2b and 3f to the closed position illustrated in FIGS. 2a and 3a, the regulator 24 raises the window 12 with the top edge 50 of the window 12 engaging the division bar 14 and pivoting the division bar 14 about the pivot pin 44 against the force of the biasing element 46 until the division bar 14 returns to the first position as illustrated in FIG. 3e. The division bar 14 is maintained in this first position by the window edge 48 as the window 12 continues to rise to the fully closed position as illustrated in FIGS. 3d, 3c, 3b and 3a. The division bar 14 may include a low friction, long wearing material on the inside surface that engages the window 12. Such a material may comprise, for example, HDPE-high density polyethylene or acetal.

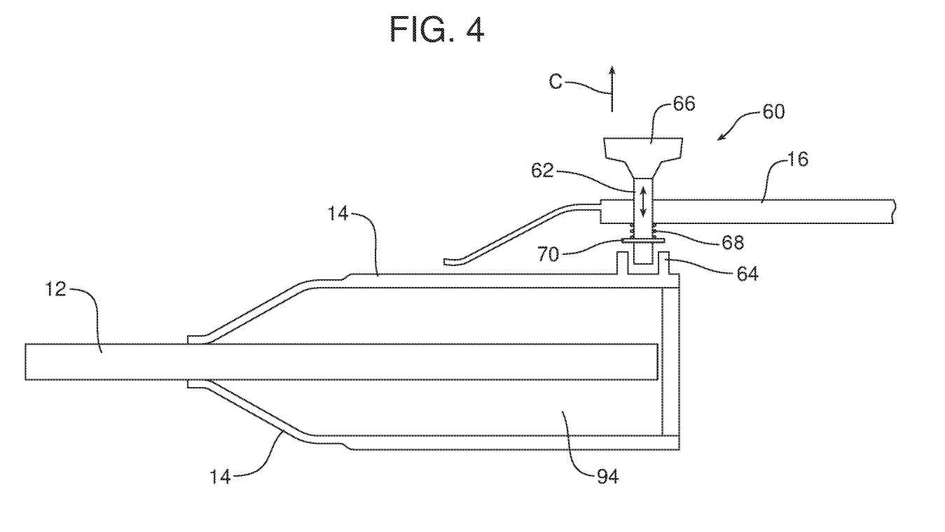

Reference is now made to FIG. 4 illustrating a first embodiment of locking feature 60 allowing one to selectively lock the division bar 14 in the raised or deployed position projecting above the top of the door panel 16 forming a part of the beltline B of the motor vehicle. In the embodiment illustrated in FIG. 4, the locking feature comprises a locking pin 62 carried on the door panel 16 and a pin receiver 64 carried on the division bar 14.

In the FIG. 4 embodiment the locking pin 62 includes a mechanical actuator in the form of a pull knob 66 and a return spring 68 to bias the locking feature into the locked position wherein the locking pin 62 is received in the pin receiver 64. That return spring 68 is concentrically received over the locking pin 62 between the locking pin flange 70 and the door panel 16.

When the locking pin 62 is engaged in the pin receiver 64 as the window 12 is displaced between the fully raised or closed position illustrated in FIGS. 2a and 3a, and the fully lowered or opened position as illustrated in FIGS. 2b and 3f, the division bar 14 is maintained in the raised or deployed position projecting above the top of the door panel 16. When one wishes to lower the division bar 14 into the fully concealed position within the door panel 16 illustrated in FIGS. 2b and 3f, one simply pulls the pull knob 66 against the force of the return spring 68 in the direction of action arrow C to release the locking pin 62 from the pin receiver 64. Once the locking pin 62 is so released, the biasing element 46 pivots the division bar 14 about the pivot pin 44 until the division bar is fully concealed within the door panel 16. Here it should be appreciated that the pull knob 66 may be utilized to release the locking pin 62 from the pin receiver 64 any time prior to, during or after the lowering of the window 12 into the door panel 16. When the window 12 is raised to the fully closed position illustrated in FIGS. 2a and 3a, the return spring 68 will bias the locking pin 62 back into the pin receiver 64 thereby locking the division bar once again in the raised or deployed position above the door panel 16.

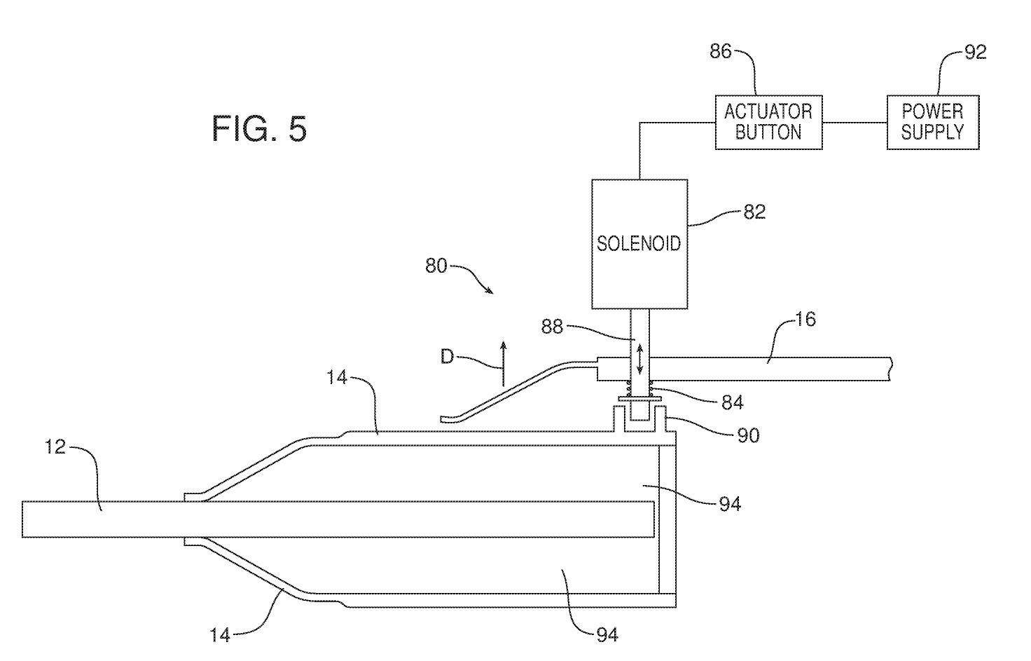

Reference is now made to FIG. 5 which illustrated an alternative embodiment of the locking feature 80. The locking feature 80 comprises an electromechanical actuator including a solenoid 82, a return spring 84 and a remote actuator switch 86 such as a pushbutton. When the locking feature 80 is in the locked position with the locking pin 88 engaged in the locking pin receiver 90, the division bar 14 is maintained in the raised or deployed position projecting above the top of the door panel 16 and the beltline B of the motor vehicle. In contrast, when the remote actuator switch or button 86 is manipulated to release the locking feature 80, power from the power supply 92 is directed to the solenoid 82 and the locking pin 88 is retracted from the pin receiver against the force of the return spring 84 (note action arrow D). This frees the division bar 14 so as to allow the biasing element 46 to pivot the division bar about the pivot pin 44 into the lowered position illustrated in FIGS. 2b and 3f once the window 12 has been fully lowered. There the division bar 14 is fully concealed within the door panel 16 in a motor vehicle.

When the window 12 is subsequently raised to the fully closed position illustrated in FIGS. 2a and 3a, the return spring 84 functions to bias the locking pin 88 back into the locking pin receiver thereby once again retaining the division bar 14 in the raised or deployed position.

In summary, either of the locking features 60 illustrated in FIG. 4 or the locking feature 80 illustrated in FIG. 5 allow an individual to lock the division bar 14 in a raised or deployed position when the window 12 is lowered into the door panel 16 when so desired. The locking feature 60 may be released by manipulation of the pull knob 66. The locking feature 80 may be released by means of the remote actuator switch or pushbutton 86. Once the locking feature 60/80 is released, the division bar 14 will pivot under the biasing force of the biasing element 46 about the pivot pin 44 into a fully lowered position concealed within the door panel 16 once the window 12 is lowered or immediately, if the window 12 has already been lowered. Here it should be noted that the division bar 14 straddles the window 12 and includes a channel 94 to accommodate the pivoting of the division bar 14 over the window 12 when the locking feature 60/80 has been released.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus, comprising
a door panel;
a division bar carried on said door panel and displaceable between a stowed position, concealed within said door panel, and a deployed position;
a biasing element biasing said division bar toward said stowed position; and
a locking feature securing said division bar in said deployed position.

2. The apparatus of claim 1, wherein said locking feature includes a locking pin carried on said door panel and a pin receiver carried on said division bar.

3. The apparatus of claim 2, further including a mechanical actuator to displace said locking pin between a pin receiver engaging position and a pin receiver releasing position.

4. The apparatus of claim 3, wherein said mechanical actuator includes a control knob.

5. The apparatus of claim 4, wherein said mechanical actuator includes a return spring.

6. The apparatus of claim 2, further including an electromechanical actuator to displace said locking pin between a pin receiver engaging position and a pin receiver releasing position.

7. The apparatus of claim 6, wherein said electromechanical actuator includes a solenoid and a remote actuator switch.

8. The apparatus of claim 2, wherein said division bar is mounted on a pivot pin carried on said door panel.

9. The apparatus of claim 8, wherein said biasing element is a torsion spring concentrically received over said pivot pin.

10. The apparatus of claim 9, wherein said door panel includes a window receiver and an internal compartment.

11. The apparatus of claim 10, further including a window and a regulator carried on said door panel and said regulator displacing said window between a closed position, projecting from said window receiver, and an opened position concealed within said internal compartment.

12. The apparatus of claim 11, wherein said regulator further includes a guide rail system for guiding said window as said window is displaced between said closed position and said opened position.

13. The apparatus of claim 12, wherein an edge of said window engages said division bar when said window projects about said pivot pin, acting to hold said division bar in said deployed position against a biasing force of said biasing element when said locking feature is released.

14. The apparatus of claim 13, wherein said division bar straddles said window.
